(19) United States
(12) Patent Application Publication
(10) Pub. No.: US 2015/0024249 A1
(43) Pub. Date: Jan. 22, 2015

(54) RECHARGEABLE LITHIUM BATTERY AND METHOD OF PREPARING THE SAME

(71) Applicant: Samsung SDI Co., Ltd., Yongin-si (KR)

(72) Inventors: Young-Chang Lim, Yongin-si (KR); Jea-Woan Lee, Yongin-si (KR); In-Seop Byun, Yongin-si (KR); Joon-Sup Kim, Yongin-si (KR); Chan Hong, Yongin-si (KR); Young-Hwan Kim, Yongin-si (KR); Seung-Hee Park, Yongin-si (KR)

(21) Appl. No.: 14/304,730

(22) Filed: Jun. 13, 2014

(30) Foreign Application Priority Data
Jul. 18, 2013 (KR) 10-2013-0084783

(51) Int. Cl. H01M 4/62; H01M 4/13; H01M 10/04; H01M 2/14; H01M 4/139; H01M 2/16; H01M 10/052

(52) U.S. Cl. CPC H01M 4/62; H01M 2/1686; H01M 2/166; H01M 4/13; H01M 10/052; H01M 4/622; H01M 2/1653; H01M 2/145; H01M 4/139; H01M 10/0436; H01M 2220/30
USPC 429/144; 29/623.5

(57) ABSTRACT

A rechargeable lithium battery includes a positive electrode, a negative electrode, a separator between the positive electrode and the negative electrode, the separator including a porous substrate and a coating layer on at least one side of the porous substrate, the coating layer including a fluorine-based polymer, a ceramic, or a combination thereof; and an electrolyte. The negative electrode includes a current collector, a negative active material layer on the current collector, the negative active material layer including a polyvinylidene fluoride (PVdF) latex particle and an aqueous binder, and a polymer layer on the negative active material layer, the polymer layer including a PVdF latex particle.

### CROSS REFERENCE TO RELATED APPLICATIONS

This application claims priority to and the benefit of Korean Patent Application No. 10-2013-0084783 filed in the Korean Intellectual Property Office on Jul. 18, 2013, the entire content of which is incorporated herein by reference.

### BACKGROUND

1. Field

This disclosure relates to a rechargeable lithium battery and a method of preparing the same.

2. Description of the Related Art

Recently, due to reductions in size and weight of portable electronic equipment, there has been a need to develop compact batteries having both high performance and large capacity.

A typical rechargeable lithium battery uses materials that reversibly intercalate or deintercalate lithium ions during charge and discharge reactions for both positive and negative active materials, and contain an organic electrolyte or a polymer electrolyte between the positive electrode and the negative electrode. Electrical energy is generated from oxidation and reduction reactions during the intercalation/deintercalation of lithium ions at the positive and negative electrodes.

In general, a battery that has a theoretical capacity depending on an active material, has a problem of charge and discharge capacity deterioration over the cycle life. The main reason is that the active material may not appropriately function, since the change in an electrode volume during repetitive charge and discharge of a battery causes separation among active materials, or between an active material and a current collector, and thus, increases internal resistance. In addition, lithium ions absorbed in the negative electrode and not appropriately released during absorption and desorption, decrease active sites of the negative electrode, and thus, deteriorate charge and discharge capacity and cycle-life characteristics of a battery.

### SUMMARY

One or more aspects of embodiments of the present invention are directed towards a rechargeable lithium battery having high safety and simultaneously excellent cycle-life characteristics.

One embodiment of the present invention provides a rechargeable lithium battery that includes a positive electrode, a negative electrode, a separator between the positive electrode and the negative electrode, the separator including a porous substrate and a coating layer on at least one side of the porous substrate, the coating layer including a fluorine-based polymer, a ceramic, or a combination thereof, and an electrolyte,

wherein the negative electrode includes a current collector, a negative active material layer on the current collector, the negative active material layer including a polyvinylidene fluoride (PVdF) latex particle and an aqueous binder, and a polymer layer on the negative active material layer, the polymer layer including a PVdF latex particle.

An average particle diameter of the PVdF latex particle may be from about 100 nm to about 200 nm.

A weight average molecular weight (Mw) of the PVdF latex particle may be from about 500,000 to about 1,000,000.

A concentration of the PVdF latex particle in the polymer layer may be higher than a concentration of the PVdF latex particle in the negative active material layer.

A concentration of the PVdF latex particle in the polymer layer may be about 1.3 times to about 3.0 times higher than the concentration of the PVdF latex particle in the negative active material layer.

A concentration of the PVdF latex particle may be higher in a region of the negative active material layer closer to the polymer layer.

A content of the PVdF latex particle may be about 50 wt % to about 80 wt % based on the total amount of the polymer layer.

The PVdF latex particle may be formed from a PVdF homopolymer, a PVdF copolymer, a PVdF graft copolymer, or a combination thereof.

The aqueous binder may include an acrylonitrile-butadiene rubber, a styrene-butadiene rubber (SBR), an acryl-based resin, hydroxyethyl cellulose, carboxylmethyl cellulose (CMC), or a combination thereof.

The porous substrate may include a polyolefin resin.

The fluorine-based polymer may include polyvinylidene fluoride (PVdF), a polyvinylidene fluoride-hexafluoropropylene (PVdF-HFP) copolymer, or a combination thereof.

The ceramic may include Al₂O₃, MgO, TiO₂, Al(OH)₃, Mg(OH)₂, Ti(OH)₄, or a combination thereof.

The ceramic may have an average particle diameter of about 0.5 μm to about 0.7 μm.

The coating layer may have a thickness of about 1 μm to about 5 μm.

The coating layer may further include a heat resistance resin including an aramid resin, a polyamideimide resin, a polyimide resin, or a combination thereof.

Another embodiment provides a method of manufacturing a rechargeable lithium battery that includes dispersing a PVdF latex particle in water to prepare an emulsion, mixing the emulsion, the negative active material and aqueous binder to prepare a negative active material layer composition, applying the negative active material layer composition on a current collector, and drying the same to manufacture a negative electrode, applying a coating layer composition on at least one side of a porous substrate to manufacture a separator, and impregnating a positive electrode, the negative electrode and the separator in an electrolyte, wherein the coating layer composition includes a fluorine-based polymer, a ceramic, or a combination thereof.

The aqueous binder may include an acrylonitrile-butadiene rubber, a styrene-butadiene rubber (SBR), an acryl-based resin, hydroxyethyl cellulose, carboxylmethyl cellulose (CMC), or a combination thereof.

A solid concentration of the PVdF latex in the emulsion may be about 20 wt % to about 40 wt %.

The PVdF latex particle may be dispersed in an amount of about 10 parts by weight to about 30 parts by weight based on 100 parts by weight of the aqueous binder.

The PVdF latex particle may be formed from a PVdF homopolymer, a PVdF copolymer, a PVdF graft copolymer, or a combination thereof.

A rechargeable lithium battery having high safety and simultaneously excellent cycle-life characteristics may be realized.

### BRIEF DESCRIPTION OF THE DRAWINGS

FIG. 1 is a schematic view showing a rechargeable lithium battery according to one embodiment of the present invention.

FIG. 2 is a graph showing a concentration distribution of the PVdF latex particle in the negative active material layer and the polymer layer of the negative electrode for a rechargeable lithium battery according to Example 3.

FIG. 3 is a graph showing capacity retention depending on a cycle of the rechargeable lithium battery cell according to Example 1 and Comparative Example 1 at room temperature (25° C.) and at high temperature (45° C.).

FIG. 4 is a graph showing a cell swelling ratio of the rechargeable lithium battery according to Example 1 and Comparative Example 1 at room temperature (25° C.) and at high temperature (45° C.).

FIG. 5 is a graph showing buckling strength of the rechargeable lithium battery cell according to Examples 1 to 3 and Comparative Example 1.

### DETAILED DESCRIPTION

Hereinafter, embodiments are described in detail. However, these embodiments are exemplary, and this disclosure is not limited thereto. In the following detailed description, certain exemplary embodiments of the present invention are shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals generally designate like elements throughout the specification. Further, the use of “may” when describing embodiments of the present invention refers to “one or more embodiments of the present invention.”

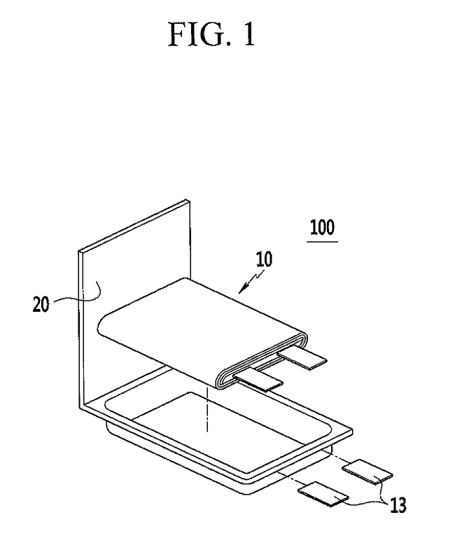

A rechargeable lithium battery according to one embodiment is described referring to FIG. 1.

FIG. 1 is a schematic view of a rechargeable lithium battery according to one embodiment.

Referring to FIG. 1, a rechargeable lithium battery 100, according to one embodiment, includes an electrode assembly 10, a battery case 20 housing the electrode assembly 10, and an electrode tab 13 playing a role of an electrical channel for externally inducing a current formed in the electrode assembly 10.

Both sides of the battery case 20 are overlapped and sealed. In addition, an electrolyte is injected into the battery case 20 housing the electrode assembly 10.

The electrode assembly 10 includes a positive electrode, a negative electrode facing the positive electrode, and a separator between the positive and negative electrodes.

The negative electrode, according to one embodiment, includes a current collector, a negative active material layer on the current collector, the negative active material layer including a polyvinylidene fluoride (PVdF) latex particle and an aqueous binder, and a polymer layer on the negative active material layer, the polymer layer including PVdF latex particles.

In some embodiments, the PVdF latex particles may include a semi-crystalline fluoropolymer prepared through an emulsion polymerization process. The semi-crystalline PVdF latex particles prepared through an emulsion polymerization process may have a smaller average particle diameter than common PVdF particles prepared through a suspension polymerization process. In some embodiments, since a negative electrode including the PVdF latex particles with a smaller average particle diameter has a small volume expansion and does not significantly expand during charge/discharge, adherence of the negative electrode to a separator may be improved. In some embodiments, an average particle diameter of the PVdF latex particle may be from about 100 nm to about 200 nm, and in some embodiments, from about 150 nm to about 170 nm. When the PVdF latex particles have an average particle diameter within the range, a negative active material layer composition having excellent water-dispersion characteristics and affinity for the coating layer of the separator may be prepared. Such characteristics provide improved adherence to the separator when the negative active material layer composition is coated and dried to manufacture a negative electrode.

A weight average molecular weight (Mw) of the PVdF latex particle may be about 500,000 to about 1,000,000, and in some embodiments, from about 500,000 to about 600,000.

When the PVdF latex particles have an average molecular weight (Mw) within the range, the PVdF latex particles may have the appropriate average particle diameter providing excellent water-dispersion characteristics when the PVdF latex particles are prepared by an emulsion polymerization process.

A concentration of the PVdF latex particle in the polymer layer may be higher than a concentration of the PVdF latex particle in the negative active material layer. In some embodiments, the concentration of PVdF latex particles in the negative active material layer follows a concentration gradient with a higher concentration of the PVdF latex particles in the negative active material layer closer to the polymer layer. In some embodiments, the concentration of the PVdF latex particle in the polymer layer may be about 1.3 times to about 3.0 times, and in some embodiments about 1.5 times to about 2.0 times, higher than the concentration of the PVdF latex particle in the negative active material layer.

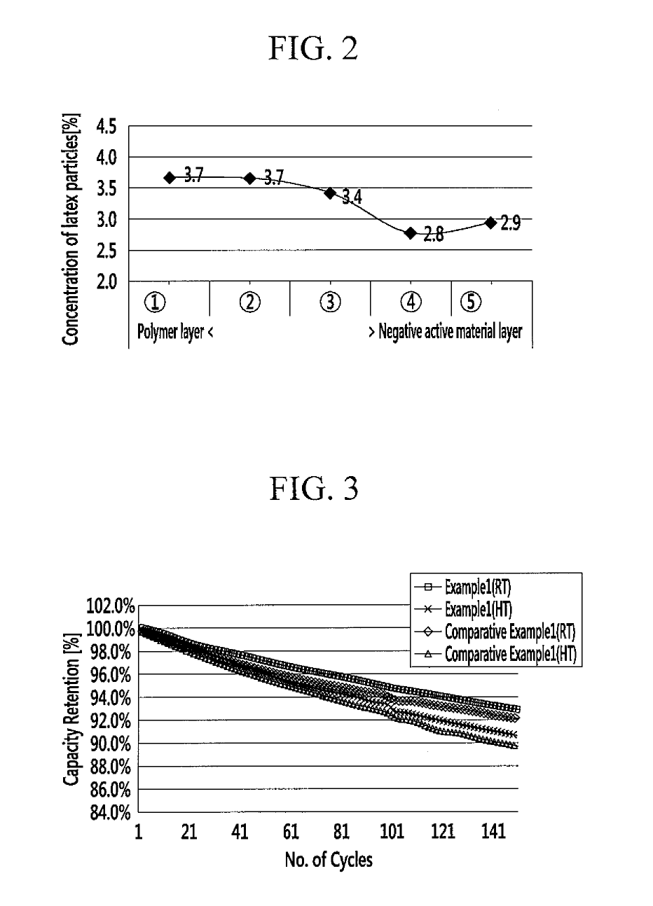

A distribution of the PVdF latex particle is described referring to FIG. 2.

FIG. 2 is a graph showing a concentration distribution of the PVdF latex particle in the negative active material layer and the polymer layer of the negative electrode for a rechargeable lithium battery according to Example 3.

Referring to FIG. 2, the concentration of PVdF latex particles in the negative electrode of Example 3 is higher on the surface of the negative electrode, toward to the polymer layer. The reason for this distribution gradient is that the PVdF latex particles, along with an aqueous binder, are dispersed in water when negative active material slurry is prepared, but then move toward the surface of the negative electrode when the negative electrode is manufactured. Since, according to some embodiments, the PVdF latex particles and the aqueous binder have different affinity for each other, the PVdF latex particles may be present in a high concentration on the surface of the negative electrode and thus, may have excellent adherence to the coating layer of a separator facing the surface of the negative electrode. Accordingly, a rechargeable lithium battery may be prevented from deformation and thus, from cycle-life characteristic deterioration.

A content of the PVdF latex particle may be from about 50 wt % to about 80 wt %, and in some embodiments from about 65 wt % to about 75 wt %, based on the total amount of the polymer layer.

In embodiments where the PVdF latex particles are included within the range, adherence of the negative electrode to the coating layer of a separator is secured, providing a rechargeable lithium battery having excellent stability.

The PVdF latex particles may be formed from a PVdF homopolymer, a PVdF copolymer, a PVdF graft copolymer, or a combination thereof.

The aqueous binder may include an acrylonitrile-butadiene rubber, a styrene-butadiene rubber (SBR), an acryl-based resin, hydroxyethyl cellulose, carboxylmethyl cellulose (CMC), or a combination thereof.

The current collector may be a copper foil.

The negative active material layer may include a negative active material, a binder, and optionally a conductive material.

The negative active material may include a material that reversibly intercalates/deintercalates lithium ions, a lithium metal, a lithium metal alloy, a material being capable of doping and dedoping lithium, transition metal oxide, or a combination thereof.

The material that reversibly intercalates/deintercalates lithium ions may be a carbon material, and may be any carbon-based negative active material suitable for use in a rechargeable lithium battery, and non-limiting examples thereof may be crystalline carbon, amorphous carbon or a mixture thereof. The crystalline carbon may be non-shaped, or sheet, flake, spherical, or fiber shaped natural graphite or artificial graphite, and the amorphous carbon may be a soft carbon, a hard carbon, mesophase pitch carbonized products, fired coke, or the like.

The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, and Sn.

The material being capable of doping and dedoping lithium may be Si, SiOₓ (0<x<2), a Si—C composite, a Si-Q alloy (wherein Q is an alkali metal, an alkaline-earth metal, at least one of Group 13 to 16 elements, transition metal, a rare earth element, or a combination thereof, and is not Si), Sn, SnO₂, a Sn—C composite, Sn—R (wherein R is an alkali metal, an alkaline-earth metal, at least one of Group 13 to 16 elements, transition metal, a rare earth element, or a combination thereof; and is not Sn), or the like, and at least one of these materials may be mixed with SiO₂. Non-limiting examples of the Q and R may be, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

The transition metal oxide may be vanadium oxide, lithium vanadium oxide, or the like.

In some embodiments, the conductive material improves conductivity of an electrode. Any electrically conductive material may be used as a conductive material, unless it causes a chemical change in the battery, and non-limiting examples thereof may be a carbon-based material such as natural graphite, artificial graphite, carbon black, acetylene black, ketjen black, a carbon fiber or the like; a metal-based material such as a metal powder or a metal fiber, or the like of copper, nickel, aluminum, silver, or the like; a conductive polymer such as a polyphenylene derivative or the like; or a mixture thereof.

A method of manufacturing a negative electrode according to another embodiment of the present invention includes dispersing a PVdF latex particle in water to prepare an emulsion, mixing the emulsion, the negative active material and aqueous binder to prepare a negative active material layer composition, and applying the negative active material layer composition on a current collector and drying the same. According to some embodiments, when the negative active material layer composition is coated and dried, the PVdF latex particles are distributed in a gradation form inside the negative active material layer and form a layer-like structure (i.e. form a polymer layer including PVdF latex particles). In some embodiments, the layer-like structure formed by the PVdF latex particles condensed on the surface layer may form an interface layer good for adherence to a separator and may provide a rechargeable lithium battery having excellent adherence and high stability. In addition, the aqueous binder may become relatively dense toward the negative electrode and may form an interface layer good for adherence to a substrate.

On the other hand, a negative electrode including common PVdF (e.g. PVdF prepared through a suspension polymerization process) may not provide a rechargeable lithium battery having excellent adherence to a separator, since the common PVdF does not form the layer-like structure.

The aqueous binder may be an acrylonitrile-butadiene rubber, a styrene-butadiene rubber (SBR), an acryl-based resin, hydroxyethyl cellulose, carboxylmethyl cellulose (CMC), or a combination thereof.

In other words, the aqueous binder with the PVdF latex particles having excellent water-dispersion may be uniformly distributed in water and may provide a uniform mixture.

The emulsion may include a PVdF latex in a solid concentration ranging from about 20 wt % to about 40 wt % and in some embodiments, from about 25% to about 30%. When the emulsion includes the PVdF latex solid within these ranges, the PVdF latex particles may be uniformly dispersed without suspension.

The PVdF latex particles may be dispersed in an amount of about 10 parts by weight to about 30 parts by weight, and in some embodiments from about 15 parts by weight to about 20 parts by weight, based on 100 parts by weight of the aqueous binder. When the PVdF latex particles are included within these weight ratio ranges, interface resistance characteristics may be prevented from deterioration, while the adherence of the surface of an electrode to a separator may still be secured.

The PVdF latex particle may be formed from a PVdF homopolymer, a PVdF copolymer, a PVdF graft copolymer, or a combination thereof.

The positive electrode may include a current collector and a positive active material layer on the current collector. The positive active material layer may include a positive active material, a binder, and optionally a conductive material.

The current collector may be Al (aluminum) but is not limited thereto.

The positive active material may include lithiated intercalation compounds that reversibly intercalate and deintercalate lithium ions. In some embodiments, at least one composite oxide of lithium and a metal of cobalt, manganese, nickel, or a combination thereof may be used, and non-limiting examples thereof may be a compound represented by one of the following chemical formulae:

LiₐA_{1-b}B_{b}D₂ (0.90≦a≦1.8 and 0≦b≦0.5); LiₐE₁.bB_{b}O_{2-c}D_{c} (0.90≦a≦1.8, 0≦b≦0.5, 0≦c≦0.05); LiₐE_{2-b}B_{b}O_{4-c}D_{c} (0.90≦a≦1.8, 0≦b≦0.5, 0≦c≦0.05); LiₐNi_{1-b-c}Co_{b}B_{c}D_{α} (0.90≦a≦1.8, 0≦b≦0.5, 0≦c≦0.05, 0<α2); LiₐNi_{1-b-c}CO_{b}B_{c}O_{2-α}F_{α} (0.90≦a≦1.8, 0≦b≦0.5, 0≦c≦0.05, 0<α<2); LiₐNi_{1-b-c}Co_{b}B_{c}O_{2-α}F₂ (0.90≦a≦1.8, 0≦b≦0.5, 0≦c≦0.05, 0<α<2); LiₐNi_{1-b-c}Mn_{b}B_{c}D_{α} (0.90≦a≦1.8, 0≦b≦0.5, 0≦c≦0.05, 0<α≦2); LiₐNi_{1-b-c}Mn_{b}B_{c}O_{2-α}F_{α} (0.90≦a≦1.8, 0≦b≦0.5, 0≦c≦0.05, 0<α<2-k ); LiₐNi_{1-b-c}Mn_{b}B_{c}O_{2-α}F₂ 0.90≦a≦1.8, 0≦b≦0.5, 0≦c≦0.05, 0<α<2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GₑO₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦b≦0.1); LiₐCoG_{b}O₂ (0.90≦a≦1.8, 0.001≦b≦0.1); LiₐMnG_{b}O₂ (0.90≦a≦1.8, 0.001≦b≦0.1); LiₐMn₂G_{b}O₄ (0.90≦a≦1.8, 0.001≦b≦0.1); QO₂; QS₂; LiQS₂; V₂O₅; LiV₂O₅; LiIO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof.

The positive active material may include the positive active material with the coating layer, or a compound of the positive active material and the positive active material coated with the coating layer. The coating layer may include at least one coating element compound selected from the group consisting of an oxide of the coating element, a hydroxide of the coating element, an oxyhydroxide of the coating element, an oxycarbonate of the coating element, and a hydroxycarbonate of the coating element. The compound for the coating element may be either amorphous or crystalline. The coating element included in the coating layer may be Mg, Al, Co, K, Na, Ca, Si, Ti, V, Sn, Ge, Ga, B, As, Zr, or a mixture thereof. The coating process may include any suitable coating process as long as it does not causes any side effects on the properties of the positive active material. Non-limiting examples of the coating process include spray coating and immersing, which are well known to persons having ordinary skill in this art, so a detailed description thereof will not be provided here.

In some embodiments, the binder improves binding properties of positive active material particles with one another and with a current collector. Non-limiting examples of the binder may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, polyamideimide, polyacrylic acid, or the like, but are not limited thereto.

In some embodiments, the conductive material improves conductivity of an electrode. Any suitable electrically conductive material may be used as a conductive material, unless it causes a chemical change in the battery. Non-limiting examples thereof may be natural graphite, artificial graphite, carbon black, acetylene black, ketjen black, a carbon fiber, a metal powder, or a metal fiber of copper, nickel, aluminum, silver, or the like, and one or more of a conductive material such as a polyphenylene derivative or the like may be mixed.

In some embodiments, the separator includes a porous substrate and a coating layer formed on at least one side of the porous substrate.

The coating layer may include a fluorine-based polymer, a ceramic or a combination thereof.

The fluorine-based polymer may include polyvinylidene fluoride (PVdF), a polyvinylidene fluoride-hexafluoropropylene (PVdF-HFP) copolymer, or a combination thereof.

The ceramic may include Al₂O₃, MgO, TiO₂, Al(OH)₃, Mg(OH)₂, Ti(OH)₄, or a combination thereof.

The porous substrate may include a polyolefin resin. Non-limiting examples of the polyolefin resin may be a polyethylene-based resin, a polypropylene-based resin, or a combination thereof.

An average particle diameter of the ceramic may be from about 0.5 μm to about 0.7 μm. The ceramic having the average particle diameter within the range may be coated on the porous substrate uniformly.

The coating layer may include a heat resistance resin including an aramid resin, a polyamideimide resin, a polyimide resin, or a combination thereof, other than the ceramic.

The coating layer may have a thickness of about 1 μm to about 5 μm, and in some embodiments from about 1 μm to about 3 μm. When the coating layer has a thickness within the range, heat resistance may be improved, thermal contraction may be suppressed, and elution of a metal ion may be prevented.

Air permeability of the coating layer may be from about 150 sec/100 cc to about 600 sec/100 cc. When the coating layer has air permeability within the range, ions may transfer smoothly and thus battery performance may be improved.

In some embodiments, the electrolyte includes a non-aqueous organic solvent and a lithium salt.

In some embodiments, the non-aqueous organic solvent serves as a medium for transmitting ions taking part in the electrochemical reaction of a battery. The non-aqueous organic solvent may be selected from a carbonate-based, ester-based, ether-based, ketone-based, alcohol-based, or aprotic solvent.

The carbonate-based solvent may include, for example, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), butylene carbonate (BC), or the like.

In embodiments where the linear carbonate compounds and cyclic carbonate compounds are mixed, an organic solvent having a high dielectric constant and low viscosity can be provided. In some embodiments, the cyclic carbonate and the linear carbonate are mixed together in a volume ratio ranging from about 1:1 to about 1:9.

The ester-based solvent may be, for example methylacetate, ethylacetate, n-propylacetate, dimethylacetate, methylpropionate, ethylpropionate, γ-butyrolactone, decanolide, valerolactone, mevalonolactone, caprolactone, or the like. The ether solvent may be, for example dibutylether, tetraglyme, diglyme, dimethoxyethane, 2-methyltetrahydrofuran, tetrahydrofuran, or the like, and the ketone-based solvent may be cyclohexanone, or the like. The alcohol-based solvent may be ethanol, isopropyl alcohol, or the like.

The non-aqueous organic solvent may be used by itself or in a mixture, and when the organic solvent is used in a mixture, the mixture ratio may be controlled in accordance with a desirable battery performance.

The non-aqueous electrolyte may include an overcharge inhibitor additive such as pyrocarbonate, or the like.

In some embodiments, the lithium salt dissolved in an organic solvent supplies lithium ions in a battery, improves lithium ion transportation between positive and negative electrodes, and basically operates the rechargeable lithium battery.

Non-limiting examples of the lithium salt may be LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (wherein, x and y are natural numbers), LiCl, LiI, LiB(C₂O₄)₂ (lithium bis(oxalato) borate, LiBOB), or a combination thereof.

The lithium salt may be used in a concentration ranging from about 0.1 M to about 2.0 M. When the lithium salt concentration is within the above range, an electrolyte may have excellent performance and lithium ion mobility due to optimal electrolyte conductivity and viscosity.

In some embodiments, the positive electrode, the negative electrode, the electrolyte and the separator are used to manufacture a rechargeable lithium battery. In some embodiments, the coating layer of the separator is positioned to face the negative electrode in the rechargeable lithium battery.

Hereinafter, the embodiments are illustrated in more detail with reference to examples. However, these examples are exemplary, and the present disclosure is not limited thereto.

Furthermore, what is not described in this disclosure may be sufficiently understood by those who have knowledge in this field and will not be illustrated here.

### EXAMPLE 1

### (Manufacture of Negative Electrode)

2 wt % of a PVdF latex emulsion (PVdF homopolymer, a weight average molecular weight (Mw) of about 600,000, solid concentration: 26.08 wt %, Kynar latex, ARKEMA), 95.5 wt % of a mixture of graphite and SiO₂ as a negative active material, 1.5 wt % of a styrene-butadiene rubber (BM-451B, ZEON) as a binder, and 1 wt % of a mixture of carboxylmethyl cellulose (a mixture of BSH12 (DAI-IGHIKOGYO SEIYAKU Co., LTD.) and MAC350 (NIPPON PAPER CHEMICALS Co., LTD.) in a ratio of 1:1) as an additional binder were put in distilled water, preparing a negative active material composition. The negative active material composition was coated on a copper foil as a current collector, dried, and roll-pressed, manufacturing a negative electrode with a negative active material layer including the PVdF latex particles and the binder and a polymer layer including the PVdF latex particles. A concentration of the PVdF latex particle in the polymer layer was 1.3 times higher than the concentration of the PVdF latex particle in the negative active material layer.

### (Manufacture of Separator)

Al₂O₃ having an average particle diameter of 0.5 μm and a PVdF resin were mixed in an N,N-dimethylformamide solvent to prepare a coating layer composition, and the coating layer composition was coated on both side of a 14 μm-thick polyethylene substrate to form a 1.5 μm-thick coating layer including the Al₂O₃ and aramid resin, manufacturing a separator. The separator including the coating layer had air permeability of about 200 sec/100 cc. (Manufacture of Positive Electrode)

97.45 wt % of LiCoO₂ as a positive active material, 1.3 wt % of carbon black as a conductive material, and 1.25 wt % of polyvinylidene fluoride as a binder were added to an N-methylpyrrolidone (NMP) as a solvent, preparing a positive active material composition. The positive active material composition was coated on an aluminum (Al) thin film, dried, and roll-pressed, manufacturing a positive electrode.

### (Preparation of Electrolyte)

An electrolyte was prepared by mixing ethylene carbonate, propylene carbonate, ethylmethyl carbonate, and diethyl carbonate in a volume ratio of 20:5:40:30 and adding 1.15M LiPF₆ to the mixture.

### (Manufacture of Rechargeable Lithium Battery Cell)

The positive electrode, the negative electrode, the electrolyte, and the separator were used to manufacture a rechargeable lithium battery cell. I.

### EXAMPLE 2

A rechargeable lithium battery cell was manufactured according to the same method as Example 1 except for mixing 3 wt % of PVdF latex particles.

### EXAMPLE 3

A rechargeable lithium battery cell was manufactured according to the same method as Example 1 except for mixing 4 wt % of PVdF latex particles.

### COMPARATIVE EXAMPLE 1

A rechargeable lithium battery cell was manufactured according to the same method as Example 1 except no PVdF latex particle was included.

### EVALUATION EXAMPLE 1

### Concentration Distribution Analysis of PVdF Latex Particles in Negative Electrode

Concentration distribution of PVdF latex particles was examined using a thermal analyzer (TGA, TA Instruments), by measuring weight change depending on a temperature. The weight change of the PVdF latex particles was measured by heating each specimen at a rate of 20° C. per minute in a range of about 400° C. to 700° C. The analysis results are provided in FIG. 2.

FIG. 2 is a graph showing a concentration distribution of the PVdF latex particle in the negative active material layer and the polymer layer of the negative electrode for a rechargeable lithium battery according to Example 3. In FIG. 2, \textcircled{1} indicates the polymer layer and \textcircled{2}, \textcircled{3}, \textcircled{4} and \textcircled{5} indicates the negative active material layer.

Referring to FIG. 2, the amount of the PVdF latex particles included in the negative electrode of a rechargeable lithium battery according to Example 3 was increased toward the surface of the negative electrode, that is, from a negative active material layer towards a polymer layer.

### EVALUATION EXAMPLE 2

### Cycle-Life Characteristic Evaluation of Rechargeable Lithium Battery Cell

Each rechargeable lithium battery cell according to Example 1 and Comparative Example 1 was charged and discharged at room temperature of 25° C. or high temperature of 45° C. under the following conditions, and its cycle-life characteristic were evaluated. The results are provided in FIG. 3.

The cycle-life characteristic evaluation was performed by charging and discharging the rechargeable lithium battery cells at room temperature of 25° C. or high temperature of 45° C. at a charge potential of 0.7 C and, 4.35 V (0.025 C cut-off) and at a discharge potential of 0.5 C and 3.0 V, and measuring their capacity retentions (%).

FIG. 3 is a graph showing capacity retention depending on a cycle of the rechargeable lithium battery cells according to Example 1 and Comparative Example 1 at room temperature (RT, 25° C.) and at high temperature (HT, 45° C.).

Referring to FIG. 3, the rechargeable lithium battery cell according to Example 1 showed a slower decrease in capacity retention than the rechargeable lithium battery cell according to Comparative Example 1 and accordingly, excellent cycle-life characteristics.

### EVALUATION EXAMPLE 3

### Stability of Rechargeable Lithium Battery Cell

Thickness of the cells was measured by using a measuring device having a flat upper plate with 300 g of a load and a thickness gauge (Gauge:Mitutoyo). Swelling ratio (Expansion ratio) of the cells was calculated by converting a thickness increase rate at every 50 cycle based on the initial thickness into a percentage %. Herein, the initial thickness was measured at status of cell charge, SOC of 60%, and thickness at every 50 cycle was measured at SOC of 100%.

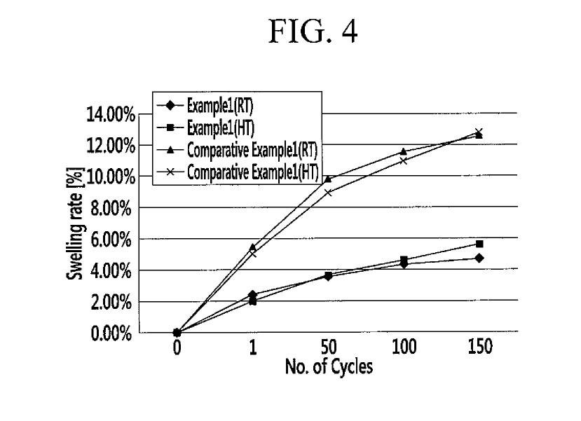

The results are provided in FIG. 4.

FIG. 4 is a graph showing a cell swelling ratio of the rechargeable lithium battery according to Example 1 and Comparative Example 1 at room temperature (RT, 25° C.) and at high temperature (HT, 45° C.).

Referring to FIG. 4, the rechargeable lithium battery cell according to Example 1 maintained a lower thickness swelling ratio than that of the rechargeable lithium battery cell according to Comparative Example 1 and thus, showed excellent stability.

### EVALUATION EXAMPLE 4

### Buckling Strength of Rechargeable Lithium Battery Cell

Adhesion strength of a separator and a negative electrode was measured by using a compression strength tester. The separator and the negative electrode according to Examples 1 to 3 and Comparative Example 1 were used to manufacture a pouch-shaped cell, and electrolyte solution according to Example 1 was impregnated therein, and then, the separator and the negative electrode were compressed at about 100° C. for 80 seconds. The pouch cells were horizontally maintained in a distance of about 15 mm and compressed by slowly increasing strength in a vertical direction.

Buckling strength refers to a strength of a cell that is bent by applying a load to the horizontally positioned polymer cell. Higher buckling strength shows stronger adherence between the negative electrode and the separator.

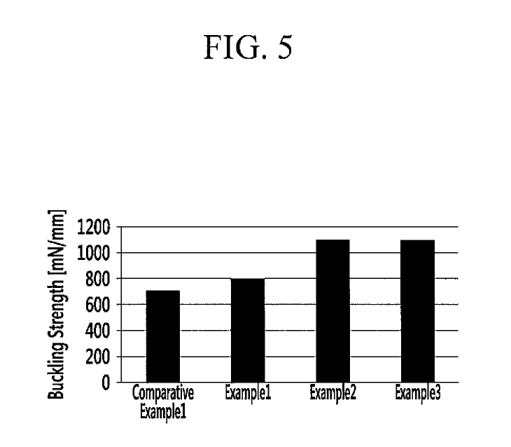

The results of the Evaluation Example 4 are provided in FIG. 5.

FIG. 5 is a graph showing buckling strength of the rechargeable lithium battery cell according to Examples 1 to 3 and Comparative Example 1.

Referring to FIG. 5, the cells according to Examples 1 to 3 showed higher buckling strength and thus, stronger adherence between the negative electrode and the separator than the cell according to Comparative Example 1.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable lithium battery comprising
a positive electrode;
a negative electrode;
a separator between the positive electrode and the negative electrode, the separator including a porous substrate and a coating layer on at least one side of the porous substrate, the coating layer comprising a fluorine-based polymer, a ceramic, or a combination thereof; and
an electrolyte,
wherein the negative electrode comprises a current collector, a negative active material layer on the current collector, the negative active material layer comprising a polyvinylidene fluoride (PVdF) latex particle and an aqueous binder, and a polymer layer on the negative active material layer, the polymer layer comprising a PVdF latex particle.

2. The rechargeable lithium battery of claim 1, wherein an average particle diameter of the PVdF latex particle is about 100 to about 200 nm.

3. The rechargeable lithium battery of claim 1, wherein a weight average molecular weight (Mw) of the PVdF latex particle is about 500,000 to about 1,000,000.

4. The rechargeable lithium battery of claim 1, wherein a concentration of the PVdF latex particle in the polymer layer is higher than a concentration of the PVdF latex particle in the negative active material layer.

5. The rechargeable lithium battery of claim 4, wherein the concentration of the PVdF latex particle in the polymer layer is about 1.3 to about 3.0 times higher than the concentration of the PVdF latex particle in the negative active material layer.

6. The rechargeable lithium battery of claim 4, wherein a concentration of the PVdF latex particle is higher in a region of the negative active material layer closer to the polymer layer.

7. The rechargeable lithium battery of claim 1, wherein the PVdF latex particle is provided in an amount from about 50 to about 80 wt % based on the total amount of the polymer layer.

8. The rechargeable lithium battery of claim 1, wherein the PVdF latex particle comprises a PVdF homopolymer, a PVdF copolymer, a PVdF graft copolymer, or a combination thereof.

9. The rechargeable lithium battery of claim 1, wherein the aqueous binder comprises an acrylonitrile-butadiene rubber, a styrene-butadiene rubber (SBR), an acryl-based resin, hydroxyethyl cellulose, carboxylmethyl cellulose (CMC), or a combination thereof.

10. The rechargeable lithium battery of claim 1, wherein the porous substrate comprises a polyolefin resin.

11. The rechargeable lithium battery of claim 1, wherein the fluorine-based polymer comprises polyvinylidene fluoride (PVdF), a polyvinylidene fluoride-hexafluoropropylene (PVdF-HFP) copolymer, or a combination thereof.

12. The rechargeable lithium battery of claim 1, wherein the ceramic comprises Al₂O₃, MgO, TiO₂, Al(OH)₃, Mg(OH)₂, Ti(OH)₄, or a combination thereof.

13. The rechargeable lithium battery of claim 1, wherein the ceramic has an average particle diameter of about 0.5 μm to about 0.7 μm.

14. The rechargeable lithium battery of claim 1, wherein the coating layer has a thickness of about 1 μm to about 5 μm.

15. The rechargeable lithium battery of claim 1, wherein the coating layer further comprises a heat resistance resin including an aramid resin, a polyamideimide resin, a polyimide resin, or a combination thereof.

16. A method of manufacturing a rechargeable lithium battery, comprising
dispersing a polyvinylidene fluoride latex particle in water to prepare an emulsion;
combining the emulsion, a negative active material, and an aqueous binder to prepare a negative active material layer composition;
applying the negative active material layer composition to a current collector and drying the same to manufacture a negative electrode;
applying a coating layer composition on at least one side of a porous substrate to manufacture a separator; the coating layer composition comprising a fluorine-based polymer, a ceramic, or a combination thereof, and
impregnating a positive electrode, the negative electrode and the separator in an electrolyte.

17. The method of claim 16, wherein the aqueous binder comprises an acrylonitrile-butadiene rubber, a styrene-butadiene rubber (SBR), an acryl-based resin, hydroxyethyl cellulose, a carboxylmethyl cellulose (CMC), or a combination thereof.

18. The method of claim 16, wherein a solid concentration of a PVdF latex in the emulsion is about 20 wt % to about 40 wt %.

19. The method of claim 16, wherein the PVdF latex particle is dispersed in an amount of about 10 parts by weight to about 30 parts by weight based on 100 parts by weight of the aqueous binder.

20. The method of claim 16, wherein the polyvinylidene fluoride latex particle comprises a polyvinylidene fluoride homopolymer, a polyvinylidene fluoride copolymer, a polyvinylidene fluoride graft copolymer, or a combination thereof.
